(19) United States
(12) Patent Application Publication
(10) Pub. No.: US 2026/0322616 A1
(43) Pub. Date: Oct. 15, 2026

(54) SYSTEMS AND METHODS FOR EFFICIENT INTEGRITY MANAGEMENT OF ARTIFICIAL INTELLIGENCE (AI) SYSTEMS

(71) Applicant: Dell Products L.P., Round Rock, TX (US)

(72) Inventors: Thuy Truong, Ovens (IE); Mustafa AlBado, Cork (IE); Zijia Wang, London (GB)

(73) Assignee: Dell Products L.P., Round Rock, TX (US)

(21) Appl. No.: 19/177,769

(22) Filed: Apr. 14, 2025

(51) Int. Cl. H04L 9/32; G06N 3/042

(52) U.S. Cl. CPC H04L 9/3236; G06N 3/042; H04L 9/3218

(57) ABSTRACT

Systems and methods for efficient integrity management of Artificial Intelligence (AI) systems are disclosed. According to one embodiment, an Information Handling System (IHS) may include executable instructions to selectively propagate only the most relevant features of a dataset to a merkle tree using an attention-driven sparse propagation process, and using the merkle tree, verify the integrity of the dataset.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

### SUMMARY

Systems and methods for efficient integrity management of Artificial Intelligence (AI) systems are disclosed. According to one embodiment, an Information Handling System (IHS) may include executable instructions to selectively propagate only the most relevant features of a dataset to a merkle tree using an attention-driven sparse propagation process, and using the merkle tree, verify the integrity of the dataset.

According to another embodiment, an Artificial Intelligence (AI) integrity management method includes the steps of selectively propagating only the most relevant features of a dataset to a merkle tree using an attention-driven sparse propagation process, and verifying the integrity of the dataset using the merkle tree.

According to yet another embodiment, a non-transitory memory storage device has program instructions stored thereon that, upon execution by an Information Handling System (IHS), cause the IHS to selectively propagate only the most relevant features of a dataset to a merkle tree using an attention-driven sparse propagation process, and using the merkle tree, verify the integrity of the dataset.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement embodiments of the present disclosure.

FIG. 2 illustrates an example AI integrity management system that may be used for data verification in AI systems according to one embodiment of the present disclosure.

FIG. 3 illustrates an example Unique Embedding Hash Function according to one embodiment of the present disclosure.

FIG. 4 illustrates several components of the resource constrained data splitter, and how they may be used to provide feature selection and propagation through the Merkle tree according to one embodiment of the present disclosure.

FIG. 5 illustrates how the Resource-Constrained Data Splitter may be used to dynamically allocate resources for dataset partitioning and verification based on available system capabilities according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

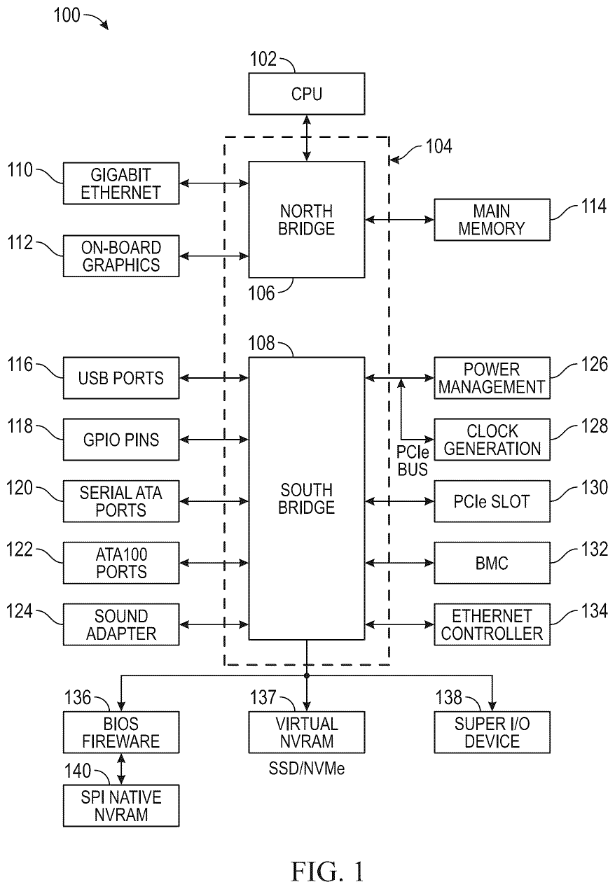

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

In enterprise-level Artificial Intelligence (AI) applications, ensuring data integrity and verification for large-scale data environments is essential to meet regulatory and security requirements. Traditional Zero-Knowledge Proof (ZKP) systems and Merkle Tree-based solutions, while foundational, face significant challenges in scalability, efficiency, and adapt-ability. These limitations are especially problematic in handling dynamic and high-volume datasets, where maintaining real-time integrity without incurring excessive computational overhead is critical. As will be described in detail herein below, embodiments of the present disclosure provide an advanced proof management system that integrates novel mechanisms with Graph Neural Network (GNN)-powered embedding generation and verification.

FIG. 1 shows an example of an IHS 100 that may be configured to implement embodiments of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, and the like. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

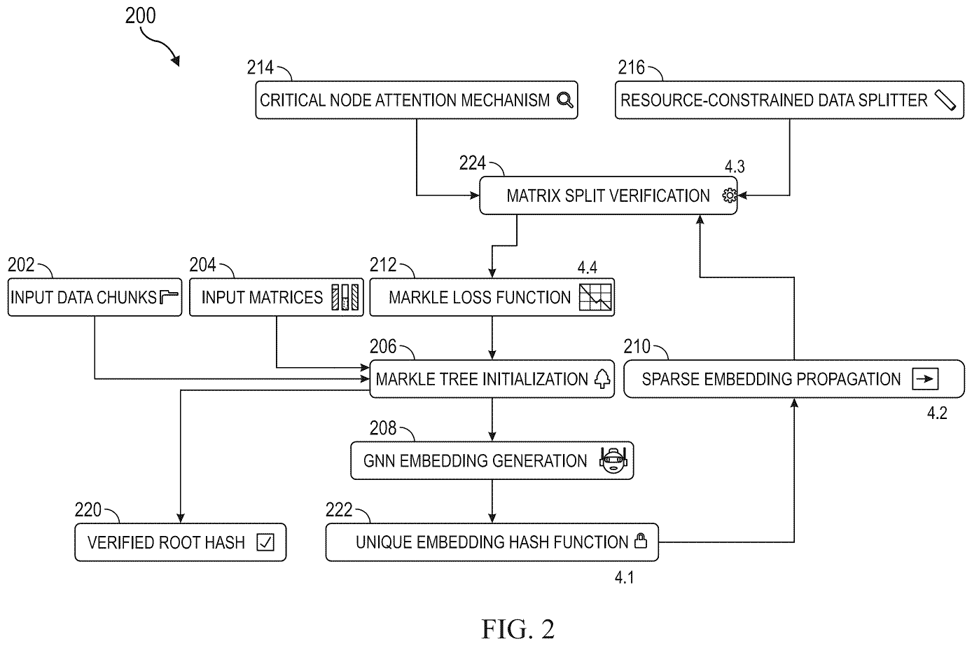

FIG. 2 illustrates an example AI integrity management system 200 that may be used for data verification in AI systems according to one embodiment of the present disclosure. The AI integrity management system 200 includes input data sources, such as input data chunks 202 and multi-dimensional input matrices 204. The core components of the AI integrity management system 200 include a Merkle Tree Initialization block 206, a GNN Embedding Generation block 208, a Sparse Embedding Propagation block 210, and the Merkle Loss Function block 212, which may collectively ensure hierarchical proof propagation, integrity enforcement, and computational efficiency. The AI integrity management system 200 may also include supporting modules, such as a Critical Node Attention Mechanism (CNAM) 214 for prioritizing verification of high-relevance nodes and a Resource-Constrained Data Splitter (RCDS) 216 for adaptive resource management. Additionally, a Verified Root Hash node 220 may provide a final output of the framework, which is a Verified Root Hash ensuring dataset integrity. Arrows indicate the data flow and interaction between components, forming a cohesive and scalable pipeline tailored for large applications, such as enterprise applications.

According to embodiments of the present disclosure, the AI integrity management system 200 leverages a Graph Neural Network (GNN)-based framework to enhance proof propagation efficiency, which may incorporate new techniques to optimize verification workflows. Key components, such as attention-driven sparse embedding propagation and integrity-enforcing loss functions, ensure the system adapts dynamically to diverse data environments. These features not only improves scalability but also strengthens the reliability and performance of the system 200.

Embodiments of the present disclosure may include a Unique Embedding Hash Function 222, which transforms GNN-generated embeddings into hash values that retain hierarchical and contextual relationships, enhancing verification efficiency while preserving data structure. Additionally, the Sparse Embedding Propagation Mechanism 210 may be provided that leverages attention-based feature selection to propagate only critical embedding features, significantly reducing computational overhead. Additionally, a Merkle Loss Function 212 is included that embeds data integrity directly into the training optimization process to reduce post-verification requirements while maintaining strict integrity. This solution offers significant value by enabling scalable, secure, and efficient data integrity management in large-scale AI applications. In some embodiments, these features may enhance enterprise-focused AI solutions while improving operational efficiency and ensuring compliance with stringent security standards.

In the realm of data integrity and verification, traditional Zero-Knowledge Proof (ZKP) systems and Merkle Tree-based solutions have been foundational. ZKP systems enable the validation of a statement without revealing the statement itself, ensuring privacy and security. However, these systems often face scalability issues when applied to large-scale data environments due to their computational complexity. Similarly, Merkle Trees, which are extensively used for data verification in distributed systems, provide efficient and secure verification mechanisms. Despite their effectiveness, Merkle Trees encounter challenges in handling dynamic and high-volume datasets, as they require significant computational resources for maintaining real-time integrity.

Recent advancements have attempted to address these limitations. For instance, a proposed a Graph Neural Network (GNN)-based framework to enhance proof of propagation efficiency. This approach leverages the hierarchical nature of GNNs to improve scalability and adaptability in dynamic data environments. Additionally, introduced sparse verification techniques may be used to reduce computational overhead by selectively propagating critical features. These methods, while innovative, still struggle with integrating data integrity directly into the training process, which is crucial for maintaining strict integrity in real-time applications.

Embodiments of the present disclosure address these challenges. The AI integrity management system 200 integrates a Unique Embedding Hash Function, which transforms GNN-generated embeddings into hash values that retain hierarchical and contextual relationships, enhancing verification efficiency while preserving data structure. Furthermore, the Sparse Embedding Propagation Mechanism 210 leverages attention-based feature selection to propagate only critical embedding features, significantly reducing computational overhead. Finally, the Merkle Loss Function 212 embeds data integrity directly into the training optimization process, reducing post-verification requirements while maintaining strict integrity.

These features not only improve scalability but also strengthen the reliability and performance of AI-driven data solutions, addressing the limitations of previous techniques. By dynamically adapting to diverse data environments, the AI integrity management system 200 offers significant value in enterprise-level AI applications, ensuring compliance with stringent security standards and enhancing operational efficiency.

Ensuring data integrity and verification in large-scale enterprise environments may be important to meet stringent regulatory and security requirements. Traditional techniques, such as Zero-Knowledge Proof (ZKP) systems and Merkle Trees provide foundational mechanisms but encounter significant limitations when applied to dynamic, high-volume datasets.

To formalize the problem, let D represent a dataset consisting of n data chunks {d1, d2, . . . , dn}. Each data chunk di has an associated proof πi generated using a cryptographic function f. The goal is to verify the integrity of the entire dataset D by validating each proof Tri while ensuring scalability, efficiency, and privacy. Formally, the verification process involves computing a root hash hroot using a Merkle Tree structure, defined as:

hroot=MerkleTree(f(d1),f(d2), . . . ,f(dn)),

and comparing hroot with an expected reference value to ensure integrity:

$$Verify ( {h}_{root} , {h}_{expected} ) = \{ \begin{matrix}1 & if {h}_{root} = {h}_{expected} , \\ 0 & otherwise .\end{matrix}$$

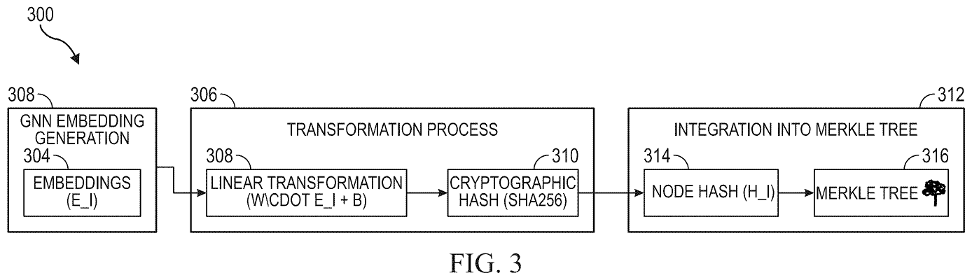

FIG. 3 illustrates an example Unique Embedding Hash Function 300 according to one embodiment of the present disclosure. In particular, FIG. 3 shows the transformation of GNN-generated embeddings into hash values, which are subsequently integrated into the Merkle Tree for verification. The Unique Embedding Hash Function 300 generally includes a GNN embedding generation block 302 that generates an array of embeddings 304, a transformation process block 306 with a linear transformation block 308 that receives the embeddings 304, and a cryptographic hash block 310 that receives transformed data from the linear transformation block 308. The Unique Embedding Hash Function 300 also includes an integration block 312 that receives node hash values 314, which areis then sent to a Merkle tree 316.

The challenge lies in achieving this verification efficiently for large-scale datasets, where resource constraints and dynamic updates significantly impact performance. Addressing this problem may present several challenges. First, traditional ZKP and Merkle Tree systems struggle with computational and memory demands when processing large datasets. Thus, efficient proof propagation mechanisms may be desired. This challenge is addressed by the Unique Embedding Hash Function 222 and Sparse Embedding Propagation block 210. Second, high-dimensional embeddings exacerbate computational overhead. A selective propagation mechanism may be required to focus on critical features without losing hierarchical integrity. This is solved by the Sparse Embedding Propagation block 210. Third, traditional methods rely on post-training integrity checks, which are inefficient for real-time applications. Embedding integrity directly into the optimization process is necessary. This is addressed by the Merkle loss function 212. Fourth, conventional Merkle Trees are inefficient for multidimensional data like matrices. A specialized verification method is required. This challenge is solved by the matrix-split verification block 224. Fifth, systems must adapt to fluctuating resources such as computational power and bandwidth to ensure scalable performance. This challenge is addressed by the resource constrained data splitter 216.

To address these challenges, the AI integrity management system 200 includes a novel Adaptive Integrity Management System that combines Graph Neural Networks (GNNs) with Merkle Trees and several innovative modules. This system ensures scalability, efficiency, and integrity for large-scale data verification in enterprise applications. The framework integrates key components, including a Unique Embedding Hash Function 222 that retains hierarchical and contextual relationships, a Sparse Embedding Propagation Mechanism 210 for reducing computational overhead, a Matrix-split Verification Method 224 for handling multidimensional data, a Merkle Loss Function 212 that embeds integrity verification into the training process, and a Resource-Constrained Data Splitter 216 for adapting to varying computational resources.

The Unique Embedding Hash Function 222 transforms GNN-generated embeddings into hash values while preserving hierarchical and contextual information. Let Ei represent the embedding generated by the GNN for the i-th node in the Merkle Tree. The hash value for this node is computed as:

Hᵢ=SHA256(W·Eᵢ+6),
where W and b are learnable parameters, and SHA256 is a cryptographic hash function that outputs a fixed-length representation. By leveraging embeddings instead of directly hashing data chunks, this approach preserves the structural relationships within the data. The embeddings are constructed to ensure that nodes with similar structural roles produce hash values that are closer in the embedding space. This property allows for efficient detection of inconsistencies in hierarchical data. The resulting hash values are then incorporated into the Merkle Tree, maintaining a balance between uniqueness and contextual dependency.

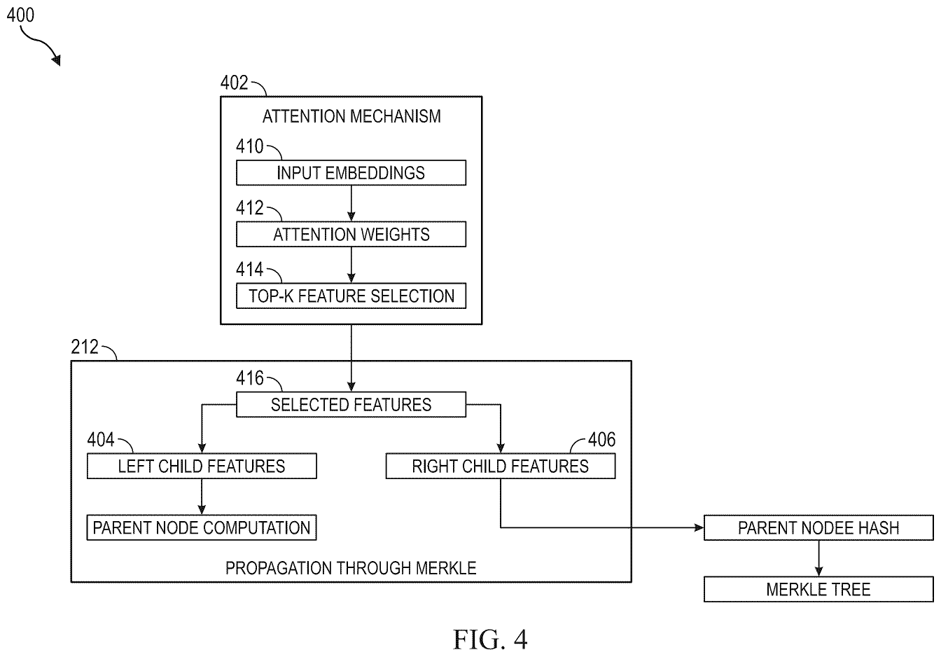

FIG. 4 illustrates several components of the resource constrained data splitter 216, and how they may be used to provide feature selection and propagation through the Merkle tree 212 according to one embodiment of the present disclosure.

In one embodiment, the sparse embedding propagation process 400 leverages an attention mechanism 402 to select the most critical features from the embeddings. For example, the attention mechanism 402 may at step 410, input the embeddings, generate attention weights for each feature at step 412, and select the top-k features at step 414. The top-k features are propagated through the Merkle Tree 212 at step 416, where parent node embeddings are computed using concatenated embeddings from the left child nodes 404 and right child nodes 406. This method reduces computational overhead while preserving hierarchical and contextual integrity.

To reduce computational overhead, the sparse embedding propagation process propagates only the most critical features of the embeddings through the Merkle Tree. Given an embedding Ei=[e1, e2, . . . , ed], where d is the dimensionality, an attention mechanism is applied to select the most important features:

$${α}_{j} = \frac{exp ( {W}_{a} \cdot {e}_{j} + {b}_{a} )}{{\sum }_{l = 1}^{d} exp ( {W}_{a} \cdot {e}_{l} + {b}_{a} )} ,$$

where aj represents the attention weight for feature j, and Wa and ba are learnable parameters. The top-k features with the highest aj values are selected for propagation:

$${E}_{i}^{′} = \{ {e}_{j} \vert {α}_{j} is among top - k \} .$$

The selected features are then propagated through the Merkle Tree. For a parent node Ep, the embedding is computed as:

$${E}_{p} = {W}_{p} \cdot [ {E}_{left}^{′} ⊕ {E}_{right}^{′} ] + {b}_{p} ,$$

where E′left and E′right are the embeddings of the left and right child nodes, ⊕ represents concatenation, and Wp and bp are learnable parameters for the parent node. This mechanism ensures that only the most relevant information is propagated, significantly reducing computational costs while preserving the integrity of the hierarchical structure.

In one embodiment, the AI integrity management system 200 may include a matrix-split verification process to handle multi-dimensional data, such as matrices. The matrix-split verification process partitions the data into smaller submatrices for efficient verification. Given a matrix M∈R^{m×n}, it may be divided into k submatrices {M1, M2, . . . , Mk} such that:

$$M = {{⋃}_{i = 1}}^{k} {M}_{i} , {M}_{i} ⋂ {M}_{j} = ∅ ∀ i \neq j .$$

Each submatrix Mi is hashed independently:

H_{M}_{ᵢ}=SHA256(flatten(Mᵢ)),
where flatten (·) converts a submatrix into a one-dimensional array. The hash values of all submatrices are integrated into the Merkle Tree, ensuring that any changes to the matrix are localized to specific submatrices, reducing the need for recomputation across the entire structure.

This method is particularly effective for parallel processing, as each submatrix can be verified independently. The hierarchical aggregation of these hash values into the Merkle Tree ensures efficient scalability for large datasets. In one embodiment, the AI integrity management system 200 may include a Merkle Loss Function 212 to embed integrity verification directly into the training process, the Merkle Loss Function aligns the embeddings with the expected integrity structure of the Merkle Tree. The loss function may be defined as:

L=L_{prediction}+λLₘₑᵣₖₗₑ,
where Lprediction is the standard prediction loss, Lmerkle penalizes deviations from the expected Merkle root hash, and λ is a scaling parameter controlling the balance between these terms. For each node embedding Ei, the Merkle loss term is computed as:

$${L}_{merkle} {{\sum }_{i = 1}}^{k} {‖ {H}_{i} - {H}_{expected , i} ‖}^{2} ,$$

where Hi is the computed hash, and Hexpected, i is the reference hash for the i-th node. By incorporating this loss into the optimization process, the model learns to generate embeddings that inherently satisfy integrity constraints, reducing the need for post-training checks.

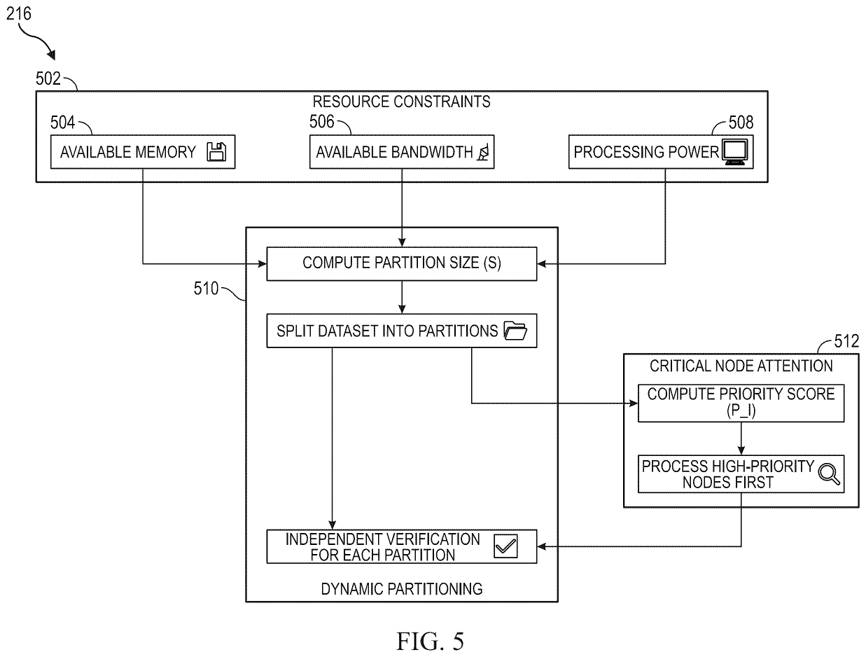

FIG. 5 illustrates how the Resource-Constrained Data Splitter 216 may be used to dynamically allocate resources for dataset partitioning and verification based on available system capabilities according to one embodiment of the present disclosure. The resource constrained data splitter 216 may include a resource constraint block 502 that gathers information about the resources of the underlying IHS 100, such as its available memory 504, available bandwidth 506, and processing power 508. The resource constrained data splitter 216 also includes a dynamic partitioning block 510 that calculates partition size, dataset splitting, and independent verification of the dataset, and a prioritization mechanism 512 where nodes are scored based on criticality and high-priority nodes are processed first.

The dynamic partitioning block 510 optimizes computational efficiency while maintaining integrity verification performance. The splitting strategy involves dynamically determining the partition size of data chunks or matrices based on the constraints of memory, bandwidth, and processing power. Let R={r1, r2, . . . , rk} represent the set of system resources, where each ri corresponds to a specific constraint such as available memory. The partition size s may be computed as:

$$s = {min}_{{r}_{i} ∈ ℛ} ( \frac{total\_resource \_capacity ( {r}_{i} )}{resource\_usage \_per \_chuck ( {r}_{i} )} ) .$$

Once the partition size is determined, the dataset is split into [N/s] partitions, where N is the total number of data elements. For each partition, verification proceeds independently, and only affected partitions are recomputed in the case of updates or changes. This ensures scalability and efficiency for high-volume datasets. Furthermore, a prioritization mechanism is employed using the Critical Node Attention Mechanism (CNAM). This mechanism assigns higher priority to nodes with a greater likelihood of being accessed or updated. Let Pi represent the priority score of the i-th node, computed as:

Pᵢ=σ(Wₚ·Eᵢ+bₚ),
where σ is a sigmoid activation function, Wp and bp are learnable parameters, and Ei is the embedding of the node. Nodes with higher Pi values are processed first, ensuring optimal use of limited resources.

To illustrate the practical implementation and alignment of the AI integrity management system 200 with an enterprise's needs, consider the scenario of verifying the integrity of data logs generated by a multi-cluster edge computing environment. These logs may be important for analytics, troubleshooting, and compliance in the enterprise's data centers. Traditional methods for verifying log integrity face challenges such as high computational costs and inability to adapt to dynamic updates.

Details of the implementation may include a Data Representation and Initialization stage, an Embedding Hash Function Integration stage, an Efficient Propagation and Resource Management stage, and a Real-Time Integrity Assurance stage as described herein below.

In the Embedding Hash Function Integration stage, each log entry is treated as a data chunk di, and these entries are hierarchically organized using a Merkle Tree. For multidimensional log data, such as logs with metadata (e.g., timestamps, user actions, and system states), the matrix-split verification Method may be applied. The log matrix M∈R^{m×n} may be split into smaller submatrices {M1, M2, . . . , Mk}, ensuring efficient and parallel verification.

In the Embedding Hash Function Integration stage, a Graph Neural Network (GNN) is trained to generate embeddings Ei for each log entry di based on its semantic and contextual attributes (e.g., sequence in the log, user ID, and system state). The Unique Embedding Hash Function 222 transforms these embeddings into hash values Hi:

Hᵢ=SHA256(W·Eᵢ+b).

These hash values are integrated into the Merkle Tree, enabling hierarchical verification while retaining contextual dependencies.

In the Efficient Propagation and Resource Management stage, the Sparse Embedding Propagation Mechanism is applied to propagate only the most relevant features of the embeddings through the Merkle Tree. For instance, features capturing system-critical actions or anomalous patterns are prioritized using an attention mechanism. Furthermore, the Resource-Constrained Data Splitter 216 can dynamically adjust the partition size of log entries based on available computational resources, ensuring scalability.

In the Real-Time Integrity Assurance stage, during training, the Merkle Loss Function aligns the model's optimization objective with the verification of the root hash of the Merkle Tree:

Lₜₒₜₐₗ=L_{prediction}+λLₘₑᵣₖₗₑ,
where Lmerkle ensures the computed root hash matches the expected hash. This real-time integration eliminates the need for expensive post-verification steps. The aforedescribed example implementation demonstrates how the AI integrity management system 200 may address and enterprise's specific needs for scalable, efficient, and adaptive integrity management in large-scale data environments, enabling superior operational efficiency and reliability.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
at least one processor comprising program instructions stored in at least one memory that, upon execution by the processor, cause the IHS to:
selectively propagate only the most relevant features of a dataset to a merkle tree using an attention-driven sparse propagation process; and
using the merkle tree, verify the integrity of the dataset.

2. The IHS of claim 1, wherein the program instructions, upon execution by the host processor, further cause the IHS to embed the dataset according to a Graph Neural Network (GNN)-based framework.

3. The IHS of claim 2, wherein the program instructions, upon execution by the host processor, further cause the IHS to transform, using a unique embedding hash function, the features into hash values that retain hierarchical and contextual relationships among the features.

4. The IHS of claim 1, wherein the wherein the merkle tree comprises a Zero-Knowledge Proof (ZKP) system.

5. The IHS of claim 1, wherein the program instructions, upon execution by the host processor, further cause the IHS to apply an attention mechanism to generate an attention weight for selecting the most relevant features.

6. The IHS of claim 1, wherein the program instructions, upon execution by the host processor, further cause the IHS to partition, using a matrix-split verification process, the dataset into a plurality of smaller submatrices for efficient verification, wherein the dataset comprises a matrix.

7. The IHS of claim 6, wherein the program instructions, upon execution by the host processor, further cause the IHS to hash each of the submatrices independently of one another.

8. The IHS of claim 6, wherein the program instructions, upon execution by the host processor, further cause the IHS to dynamically determine a partition size of the submatrices based on one or more constraints of the memory, network bandwidth, and a processing power of the processor.

9. The IHS of claim 1, wherein the program instructions, upon execution by the host processor, further cause the IHS to align, using a merkle loss function, a plurality of embeddings with an expected integrity structure of the merkle tree.

10. An Artificial Intelligence (AI) integrity management method comprising:
selectively propagating only the most relevant features of a dataset to a merkle tree using an attention-driven sparse propagation process; and
verifying the integrity of the dataset using the merkle tree.

11. The AI integrity management method of claim 10, further comprising embedding the dataset according to a Graph Neural Network (GNN)-based framework.

12. The AI integrity management method of claim 11, further comprising transforming, using a unique embedding hash function, the features into hash values that retain hierarchical and contextual relationships among the features.

13. The AI integrity management method of claim 10, further comprising applying an attention mechanism to generate an attention weight for selecting the most relevant features.

14. The AI integrity management method of claim 10, further comprising partitioning, using a matrix-split verification process, the dataset into a plurality of smaller submatrices for efficient verification, wherein the dataset comprises a matrix.

15. The AI integrity management method of claim 14, further comprising hashing each of the submatrices independently of one another.

16. The AI integrity management method of claim 14, further comprising dynamically determining a partition size of the submatrices based on one or more constraints of the memory, network bandwidth, and a processing power of the processor.

17. The AI integrity management method of claim 10, further comprising aligning, using a merkle loss function, a plurality of embeddings with an expected integrity structure of the merkle tree.

18. A non-transitory memory storage device having program instructions stored thereon that, upon execution by an Information Handling System (IHS), cause the IHS to:
selectively propagate only the most relevant features of a dataset to a merkle tree using an attention-driven sparse propagation process; and
using the merkle tree, verify the integrity of the dataset.

19. The non-transitory memory storage device of claim 18, wherein the program instructions, upon execution by the host processor, further cause the IHS to partition, using a matrix-split verification process, the dataset into a plurality of smaller submatrices for efficient verification, wherein the dataset comprises a matrix.

20. The non-transitory memory storage device of claim 18, wherein the program instructions, upon execution by the host processor, further cause the IHS to align, using a merkle loss function, a plurality of embeddings with an expected integrity structure of the merkle tree.
